(19) United States
(12) Patent Application Publication
(10) Pub. No.: US 2022/0208007 A1
(43) Pub. Date: Jun. 30, 2022

(54) SYSTEMS AND METHODS FOR COLLISION AVOIDANCE ON A HIGHWAY

(71) Applicant: Robin Arora, Huntington, WV (US)

(72) Inventor: Robin Arora, Huntington, WV (US)

(21) Appl. No.: 17/566,298

(22) Filed: Dec. 30, 2021

Related U.S. Application Data
(60) Provisional application No. 63/133,029, filed on Dec. 31, 2020.

(51) Int. Cl. G08G 1/16; G06V 20/54; G06T 7/20; G06T 7/70; B60Q 9/00; G01S 13/931

(52) U.S. Cl. CPC G08G 1/164; G06V 20/54; G06T 7/20; G06T 7/70; G06T 2207/10044; B60Q 9/008; G01S 13/931; G06V 2201/08; G06T 2207/30236; G08G 1/166

(57) ABSTRACT

Methods and systems for collision avoidance are provided. The method includes detecting, a vehicle, with one or more sensors, that is traveling on a road and determining that the vehicle is traveling in the wrong direction on the road. The method includes creating information, using data from the one or more sensors, that describes the vehicle, responsive to the determination and transmitting the information to a communicating device that is capable of communicating a message based on the information to inform other vehicles on the road that the vehicle is approaching the other vehicles on the road.

### CROSS REFERENCE TO PRIOR APPLICATION

This application claims the benefit of U.S. Provisional Patent Application No. 63/133,029, entitled as “SYSTEMS AND METHODS FOR COLLISION AVOIDANCE ON A HIGHWAY”, filed Dec. 31, 2020, which is incorporated by reference in its entirety.

### FIELD OF THE INVENTION

This disclosure relates to traffic collision prevention on highways.

### BACKGROUND

Every year numerous people are injured as the result of a vehicular accident from a vehicle travelling in the wrong direction on a highway. Vehicles travelling in the wrong direction may be driven by drivers who are tired, drunk, confused, or under the influence of a drug, who mistakenly drive onto the off ramp of a highway and drive toward oncoming traffic. As traffic may be travelling at an average rate of 65 mph, most drivers do not have enough time to react and avoid the wrong-way driver. There have been many efforts to prevent such accidents by proactively identifying drivers who are not alert enough to drive a vehicle such as with police checkpoints. However, those efforts do not alert other drivers to a dangerously driven vehicle. There is a need in the art for a system that can both warn the general public and authorities of the imminent danger of a vehicle travelling in the wrong direction on a highway.

### SUMMARY

The present disclosure includes methods for collision avoidance on a highway. In an exemplary embodiment, a method includes detecting, a vehicle, with one or more sensors, that is traveling on a road and determining that the vehicle is traveling in a wrong direction on the road. The method includes creating information, using data from the one or more sensors, that describes the vehicle, responsive to the determination and transmitting the information to a communicating device that is capable of communicating a message based on the information to inform other vehicles on the road that the vehicle is approaching the other vehicles on the road. The communicating device may be a signboard with a display. The one or more sensors may include at least one of a camera or a radar. The information may include a speed of the vehicle, a lane in which the vehicle is driving, and a distance to the vehicle. Determining that the vehicle is traveling in the wrong direction on the road may include determining that the vehicle is facing the wrong direction based on an image of the vehicle that is taken by the one or more sensors. The method may further include activating a vehicle disabling device that is configured to stop the vehicle. The communicating device may include a display in one of the other vehicles.

In an exemplary embodiment, a collision avoidance system includes one or more sensors that can detect a vehicle that is travelling on a road and create data based on the vehicle and a computer that is configured to determine that the vehicle is traveling in the wrong direction on the road based on the data. The computer is further configured to create information that describes the vehicle based on the data and transmit the information to a communicating device that is capable of communicating a message based on the information to inform other vehicles on the road that the vehicle is approaching the other vehicles on the road. The one or more sensors may include at least one of a camera or a radar. The information may include a speed of the vehicle, a lane in which the vehicle is driving, and a distance to the vehicle. The computer may be configured to determine that the vehicle is traveling in the wrong direction on the road by determining that the vehicle is facing the wrong direction based on an image of the vehicle that is taken by the one or more sensors. The system may further include a vehicle disabling device that is configured to stop the vehicle. The communicating device may include a display in one of the other vehicles.

In another general aspect, a computer readable storage medium in a collision avoidance apparatus having data stored therein representing a software executable by a computer, the software comprising instructions that, when executed, cause the collision avoidance apparatus to perform detecting, a vehicle, with one or more sensors, that is traveling on a road and determining that the vehicle is traveling in a wrong direction on the road. The instructions further cause the collision avoidance apparatus to perform creating information, using data from the one or more sensors, that describes the vehicle, responsive to the determination and transmitting the information to a communicating device that is capable of communicating a message based on the information to inform other vehicles on the road that the vehicle is approaching the other vehicles on the road. The communicating device may be a signboard with a display. The one or more sensors may include at least one of a camera or a radar. The information may include a speed of the vehicle, a lane in which the vehicle is driving, and a distance to the vehicle. Determining that the vehicle is traveling in the wrong direction on the road may include determining that the vehicle is facing the wrong direction based on an image of the vehicle that is taken by the one or more sensors. The instructions may further cause the collision avoidance apparatus to activate a vehicle disabling device that stops the vehicle. The communicating device may include a display in one of the other vehicles.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the present disclosure are utilized, and the accompanying drawings of which:

FIG. 1A illustrates an example of the collision avoidance device according to an embodiment of the present disclosure.

FIG. 1B illustrates a schematic of the collision avoidance device according to an embodiment of the present disclosure.

FIG. 1C is an illustration of the collisional avoidance system alerting vehicles of a wrong-way driver.

FIG. 2 illustrates an example of the collision avoidance device according to an embodiment of the present disclosure.

FIG. 3 illustrates an example of the collision avoidance device according to an embodiment of the present disclosure.

FIG. 4 is an illustration of a vehicle driving the wrong way on a road

FIG. 5 illustrates an example of a collision avoidance system according to an embodiment of the present disclosure.

FIG. 6 illustrates a diagram of the collision avoidance device as it operates from an overhead view.

FIG. 7 illustrates an example of a flow diagram according to an embodiment of the present disclosure.

FIG. 8 illustrates a diagram of the vehicle disabling component for the collision avoidance device according to an embodiment of the present disclosure.

FIG. 9 illustrates an example of the collision avoidance device with a vehicle disabling component according to an embodiment of the present disclosure.

FIG. 10 is a schematic of a computing system that may be utilized in embodiments of the present disclosure.

### DETAILED DESCRIPTION

The disclosed subject matter describes a method and system for preventing collisions on roads such as highways. For various reasons, such as being confused, drivers may enter an off-ramp of a highway thinking it is an on-ramp. Vehicles being driven by drivers under the influence of drugs or alcohol have an increased tendency to mistakenly drive on the wrong side of the road. Once on the highway and driving in the wrong direction, the confused drivers may attempt to get off the highway by pulling to the right (assuming that traffic drives on the right side of the road) which exacerbates the situation as the action effectively keeps them on the highway and in the fastest lane. The system alerts other vehicles on the road to the vehicle that is driving the wrong way. The alerted vehicles can take evasive action such as exiting the highways or pulling over to the side of the road. The vehicle that is driving the wrong way may also be alerted so that the confused driver of the wrong way vehicle may correct the direction of the vehicle.

The system may detect a vehicle that is driving in the wrong direction by using sensors such as cameras and radar. The sensors may be placed at various locations such as at highway exits, which is where vehicles may begin driving on the wrong side of the road. Once the vehicle that is driving the wrong way is detected by the sensors, one or more displays that are visible to vehicles of the road may display an alert that there is a vehicle driving the wrong way. The one or more displays may comprise various display technologies such as liquid crystal displays (“LCD”s) and light emitting diodes (“LED”s). The LCD or LED displays may warn other drivers of the vehicle that is traveling in the wrong direction by displaying a speed, lane number, and approximate distance to the vehicle that is driving in the wrong direction. The speed, lane number, and distance information may also be passed to police authorities.

In various embodiments, the system may comprise a board that is visible from a highway. The board may have various sensors such as a camera and radar. In an exemplary embodiment, the board contains one camera and one radar. The camera and radar may detect vehicles as the vehicles drive past the board. The sensors may detect whether the vehicles are driving in the wrong direction on the highway and generate an alert. The board may be powered by various means such as a solar power panel and a battery pack. The board may have a circuit board that connects the various electric components of the board. The board may have a display on both sides of the board that can display a warning that a vehicle is driving on the wrong side of the road. In various embodiments, the board may contain multiple cameras and multiple radars. In one example, the board may contain two radars and two cameras. In another example, the board may contain three radars and three cameras. The increased number of radars and cameras effectively increase the number of lanes in a road for which the sensors can detect a vehicle that is traveling in the wrong direction. The board may include a communication component such as an antenna. The communication component can pass information on a vehicle that is traveling in the wrong direction to other boards. The communication component can also pass information to authorities such as a local police department.

The collision avoidance device includes a digital sign board on a highway, a camera and radar attached behind the digital sign board, an antenna, and sensors attached below the digital sign board. The system can detect a vehicle traveling in the wrong direction on a highway. The camera can take pictures of the vehicle and create a description of the vehicle for the general public and authorities, while the radar can detect the vehicle and determine the speed and distance of the vehicle. Together, the camera and radar can send the information to the antenna, which can transmit the information to the authorities and general public via 3G, LTE, 5G, and wifi networks. In this way, the general public may be able to receive a warning on their phone or through third-party mobile applications. The information sent to the antenna may also be sent to the digital sign board which can display warning messages to the general public. The digital messages may include messages such as, “Warning! Oncoming vehicle approaching! Get over or take next exit!” The sensors below the digital sign board can detect the amount of traffic traveling toward the vehicle driving in the wrong direction.

The system may include a vehicle disabling device that is configured to disable a vehicle in response to detecting that the vehicle is travelling in the wrong direction. In an exemplary embodiment, the vehicle disabling device comprises a retractable spike strip. The retractable spike strip may be activated by an automated system that selectively disables the vehicle that is traveling in the wrong direction. In various embodiments, the vehicle disabling device is an antenna that transmits a signal that, when received, activates a vehicle disabling system in the wrong way vehicle. The vehicle disabling system may embody various other mechanisms that, when employed, disable a moving vehicle.

The retractable spike strip may be operated by an underground hydraulic lifting device that is powered by an electric motor. The electric motor may be connected to both a cellular circuit and an emergency vehicle pre-emption device. The device may be capable of puncturing the tires of a wrong-way vehicle entering the off ramp, thereby slowing or disabling the vehicle. The retractable spike strip may retract when signaled to avoid disabling other vehicles including authorities. The signal may be through a cellular network or by the authorities' siren.

In general, this device will help to protect the driving public by detecting vehicles that are traveling in the wrong direction on a road or highway and generating an alert in response to detecting the vehicles. In the current market, there is a lack of devices that can prevent cars from entering the highway via an off ramp. Wrong way vehicles may be driven by individuals that are confused or delirious for various reasons. Wrong way vehicles may also be driven by emergency personnel in order to aid those in an accident. The collision avoidance system can detect the approaching wrong way vehicles and direct the traffic off the highway or toward the side of the road.

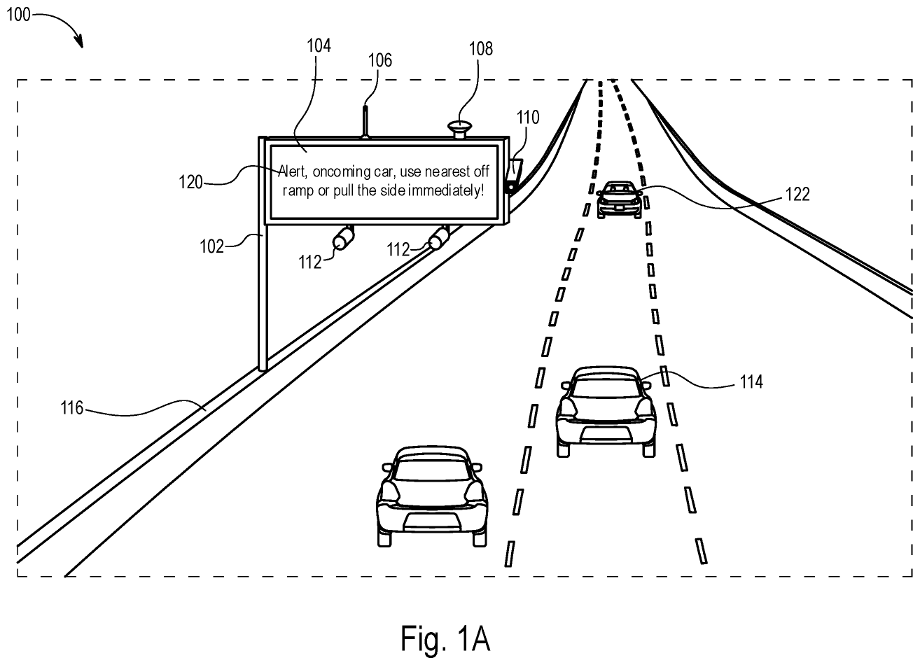

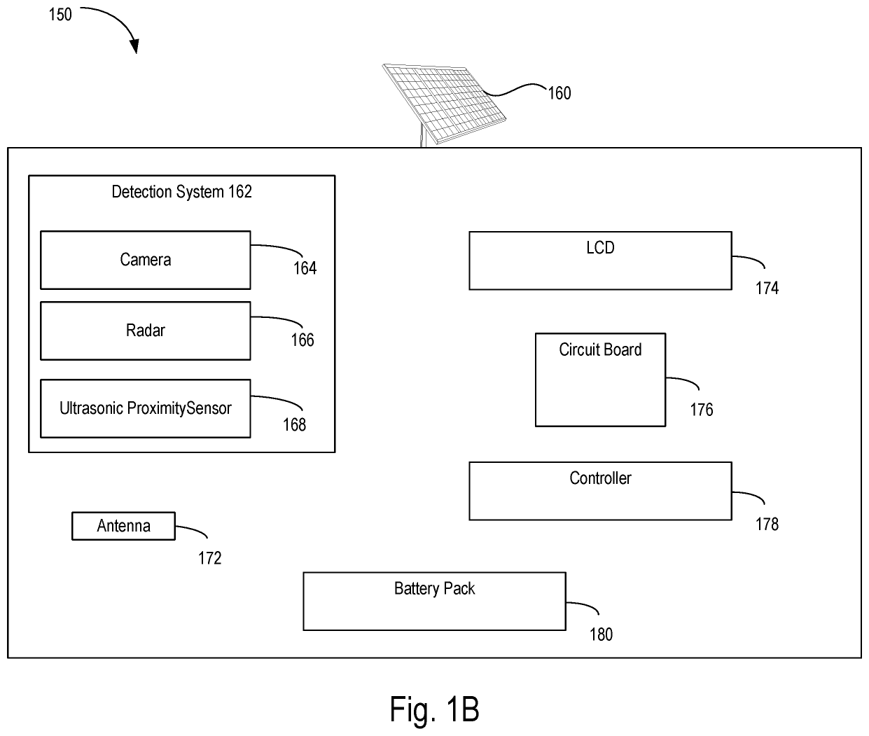

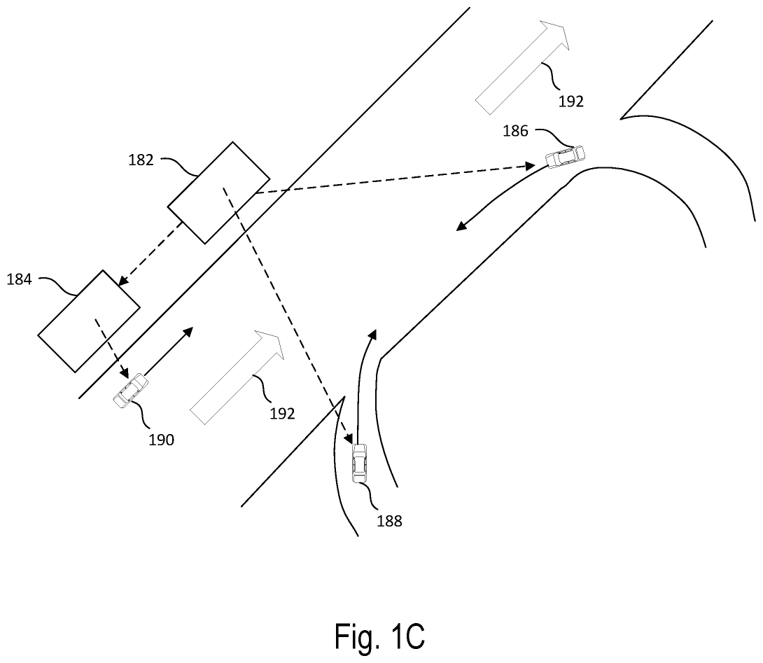

Referring to FIG. 1A, FIG. 1A illustrates an example of the collision avoidance device 100, according to an embodiment of the present disclosure. The collision avoidance device 100 is a system that can detect a vehicle driving onto the highway in the wrong direction. The collision avoidance device 100 may warn other drivers of a vehicle driving toward them and suggest an alternative route.

The collision avoidance device 100 may include a mount 102, a digital sign board 104, an antenna 106, a radar 108, a camera 110, and a sensor 112. The collision avoidance device 100 may detect a correct direction of traffic 118 on a highway 116. One or more vehicles 114 and a wrong-way vehicle 122 may be detected with the collision avoidance device 100. Digital messages 120 may be transmitted by the collision avoidance device 100 in response to detecting a wrong-way driver.

The digital sign board 104 may be attached to the mount 102. The mount 102 is a structure that holds the digital sign board 104 erect. The mount 102 may be a cylindrically shaped pole that is made of steel. The mount 102 may be secured into the ground on the edge of the highway. In various embodiments, the mount 102 may be in a square, triangle, hexagon, or octagon shape. The mount 102 may also be made of various materials such as aluminum, brass, copper, stainless steel, wrought iron, iron, and titanium.

The digital sign board 104 may include an LCD screen that can display messages to the general public. The digital sign board 104 may have various shapes such as circle, oval, square, triangle, octagon, hexagon, etc. that facilitate the communication of messages to highway drivers. The digital sign board 104 may be elevated by the mount 102 to face drivers on a highway from various positions. In various embodiments, the digital sign board 104 screen may be a liquid crystal display (LCD), organic light emitting diode (OLED), light emitting diode (LED), plasma, or quantum dot display (QLED).

The antenna 106 may be attached to the digital sign board 104. The purpose of the antenna 106 is to transmit and receive data regarding collision avoidance. The antenna 106 may transmit messages via wireless protocols such as 3G, LTE, 5G, or wife. The antenna 106 transmission may be received by additional digital sign boards 104 whereby a message regarding a wrong way driver may be propagated to multiple digital sign boards 104 in response to the detection of the wrong way driver. The antenna 106 may also transmit a signal to police authorities and the general public.

The radar 108 may be attached to the digital sign board 104. The radar 108 emits and receives pulses of light. Objects in the path of an emitted pulse of light may reflect the pulse back to the radar, which may receive the reflected pulse. The radar may determine the direction of an object in relation to the radar 108 based on the angle of reception of a pulse. The distance to the object may be determined by the radar based on the time difference between the emission and reception of a pulse.

The radar 108 may detect a vehicle by receiving a pulse of light that is reflected from the vehicle. The radar 108 may determine the position of the vehicle based on the angle and distance determined from a reception of a pulse of light. The radar 108 may also use various radar technologies including, but not limited to pulse radar, continuous radar, moving target indication radar, frequency modulated continuous wave radar, passive radar, Fm-cw radar, and doppler radar. The radar 108 may determine the velocity of the vehicle by measuring the change in position of the vehicle over time. A change in position that indicates that a vehicle is driving in the wrong direction on a road may trigger an alarm. The radar 108 may be located at various positions on and around the digital sign board 104 or attached to the mount 102.

A camera 110 may detect vehicles by taking images of vehicles and recognizing the vehicle. The vehicle may be recognized by processing the image with a machine learned algorithm. The machine learned algorithm may be created and taught to recognize an image of a vehicle in various way such as by training a naive algorithm with a multitude of vehicle images. In various embodiments, the machine learned algorithm may be taught to identify a make, model, year, color, and identifying characteristics of vehicle images.

The vehicle may be recognized and positioned with a single camera image. Further, the camera may ascertain the traveling direction of the vehicle from the direction that the vehicle is facing and assuming that the vehicle is travelling in a forward direction. By taking multiple images, the camera may determine the exact velocity of the vehicle by measuring the distance that the vehicle travels over time. The camera 110 may use various camera technologies such as stereoscopic vision and night vision. In various embodiments, vehicle features may be determined through an image of the vehicle license plate, reading the license plate number, and matching the license plate number to a specific vehicle.

Information that is detected by the radar 108, camera 110, or other sensors may be transmitted by an antenna 106 to a computer system or other digital sign boards. The computer system may be a single computer, a de-localized computer system, a cloud computer system, or the like. The computer system may process sensor data to determine if a vehicle is travelling in the wrong direction on a road. For example, the computer system may process multiple images of a vehicle to determine the direction in which the vehicle is travelling. The computer system may process data from multiple sensors to verify that a vehicle is driving in the wrong direction. Alternatively, the computer system may process data, from a single sensor, that is collected over a period of time. And alternatively, the computer system may process data from a single measurement of a sensor to determine if a vehicle is travelling in the wrong direction on a road.

In various embodiments, sensors other than radar or cameras may be used to determine that a vehicle is travelling in the wrong direction on a road. In one embodiment, a Lidar sensor is used to detect the position and velocity of a vehicle. A Lidar sensor operates under similar principles to radar, where light pulses in a Lidar sensor are typically in the ultraviolet to visible to near infrared range. In an exemplary embodiment, an ultrasonic proximity sensor may be used to determine the position and/or velocity of a vehicle to determine that a vehicle is travelling in the wrong direction on a road. Ultrasonic proximity sensors emit ultrasonic sound waves and determine the distance to an object by the time it takes for a sound wave to be reflected back to the ultrasonic proximity sensor.

In one embodiment, the sensor comprises an ultrasonic proximity sensor that may be attached to the underside of the digital sign board 104. The ultrasonic proximity sensor may detect vehicular traffic directly under the digital sign board 104. A multitude of ultrasonic proximity sensors, or the like, may be positioned on the underside of a digital sign board 104 to detect vehicles in every lane of a road. The multitude of ultrasonic proximity sensors may determine the amount of vehicular traffic on a road. In various embodiments, multiple ultrasonic proximity sensors in the same lane may be used to determine the velocity of a vehicle by measuring the time difference between detections of the multiple ultrasonic proximity sensors. A vehicle that is traveling in the wrong direction may be detected by determining the vehicle to have a velocity in the wrong direction.

One or more vehicles 114 travelling in the correct direction of the road may be detected by the various sensors used in the system described herein that are used to detect vehicles that are traveling in the wrong direction. The one or more vehicles 114 travelling in the correct direction may be targeted on the digital sign board with digital warning messages. The digital messages 120 are produced by the digital sign board 104. The digital messages 120 may consist of emergency warnings to the vehicles 114 about the wrong-way vehicle 122 travelling in the wrong direction driving toward them.

The warning messages may be modified based on the number of vehicles 114 that are traveling in the correct direction. For example, a message under heavy traffic conditions may be more generic than a message under sparse traffic conditions. Under heavy traffic conditions, for example, an instruction to take the first off-ramp and get off the highway may not be feasible for all vehicles while it would be feasible under sparse traffic conditions. Instead, a more generic instruction to slow down and be on the lookout would be more appropriate in heavy traffic conditions.

The digital sign board may be positioned to display digital messages 120 to as many vehicles 114 as possible on the road. As such, the digital sign board 104 may be placed at conspicuous locations such as prominently above a road or on the side of a road. Multiple digital sign boards 104 may be coordinated to display the same or close to the same digital messages 120.

Referring to FIG. 1B, FIG. 1B illustrates a schematic of the collision avoidance device 150, according to an embodiment of the present disclosure. The collision avoidance device 150 may detect a vehicle driving onto the highway in the wrong direction. The collision avoidance device 150 may also warn other vehicles 114 about the wrong-way vehicle 122 driving toward them in response to determining that the wrong-way vehicle 122 is driving in the wrong direction. The collision avoidance device 150 may further suggest evasive action or suggest an alternative route. The collision avoidance device may also warn a wrong-way vehicle 122 of the mistake of driving in the wrong direction and suggest an action to right the direction of the wrong-way vehicle 122.

The collision avoidance device 150 includes a solar panel 160, a detection system 162, an LCD board 174 for display, a circuit board 176, a controller 178, an antenna 172, and a battery pack 180. The detection system 162 detects the position and velocity of vehicles as vehicles travel on a road. The detection system 162 may determine that a vehicle is travelling in the wrong direction on a road. The detection system 162 may comprise a variety of sensors to detect position and velocity of vehicles. The sensors in the detection system may be connected to various other components of the collision avoidance device through a circuit board. In an embodiment shown in FIG. 1B, the detection system 162 includes a camera 164, a radar 166, and an ultrasonic proximity sensor 168. The camera 164 may determine the position and velocity of vehicles by taking images of the vehicles. The images may be processed by the controller 178 whereby the controller 178 may determine if the images show a vehicle traveling in the wrong direction. If the controller determines the vehicle to be travelling in the wrong direction, the images may be further used to identify and describe the vehicle that is travelling in the wrong direction. An image of the wrong-way vehicle 122 may be transmitted by the antenna 172 to signs, authorities, or other collision avoidance devices 150. The image of the vehicle may be displayed by the LCD board 174 for display to identify the wrong-way vehicle 122 for vehicles 114 that are traveling on the correct side of the road.

The radar 166 and ultrasonic proximity sensor 168, like the camera 164, may be used to determine the position and velocity of vehicles on the road. Data from the radar 166 and ultrasonic proximity sensor 168 may be processed by the controller 178 to determine the position and velocity. Data from the radar 166 and ultrasonic proximity sensor 168 may be transmitted to other collision avoidance devices 150 to determine the positions and velocities of vehicles over a large area.

The LCD board 174 displays images and text that is visible to drivers on the road. In various embodiments, the LCD board 174 may comprise other display technologies. The LCD board 174 may display images on one or both sides of a digital sign board. The display may contain text that directs vehicles to a safe location. The LCD board 174 may display an image of a wrong-way vehicle 122. The LCD board 174 may display a generated image of the lane that has the wrong-way vehicle 122.

The circuit board 176 may connect the various components of the collision avoidance device 150. The components of the detection system 162 may send data through the circuit board 176 to the controller 178. The controller 178 may send and receive data from the antenna 172 through the circuit board 176. The LCD board 174 may receive data from the controller 178 to display. The battery pack 180 may power the various components of the collision avoidance device 150 through the circuit board 176. The solar panel 160 may charge the battery pack 180 through the circuit board 176.

Referring to FIG. 1C, FIG. 1C is an illustration of the collision avoidance system alerting vehicles of a wrong-way driver. A digital sign board 182 has sensors that can detect the direction that vehicles are driving on a road with a correct direction of travel 192. The digital sign board 182 may detect a vehicle 186 that enters the road driving in the wrong direction. The digital sign board may display an alert to vehicle 188. The digital sign board may also transmit the alert to a second digital sign board 184. The second digital sign board 184 may replicate the alert for vehicle 190.

The alert may be replicated any number of times and transmitted to any number of digital sign boards. The alert may inform vehicle 188 and vehicle 190 that vehicle 186 is driving in the wrong direction. In various embodiments, the alert may suggest a lane, an alternate path, or direct evasive action. The digital sign board may also direct an alert to vehicle 186 informing it that that vehicle 186 is driving in the wrong direction.

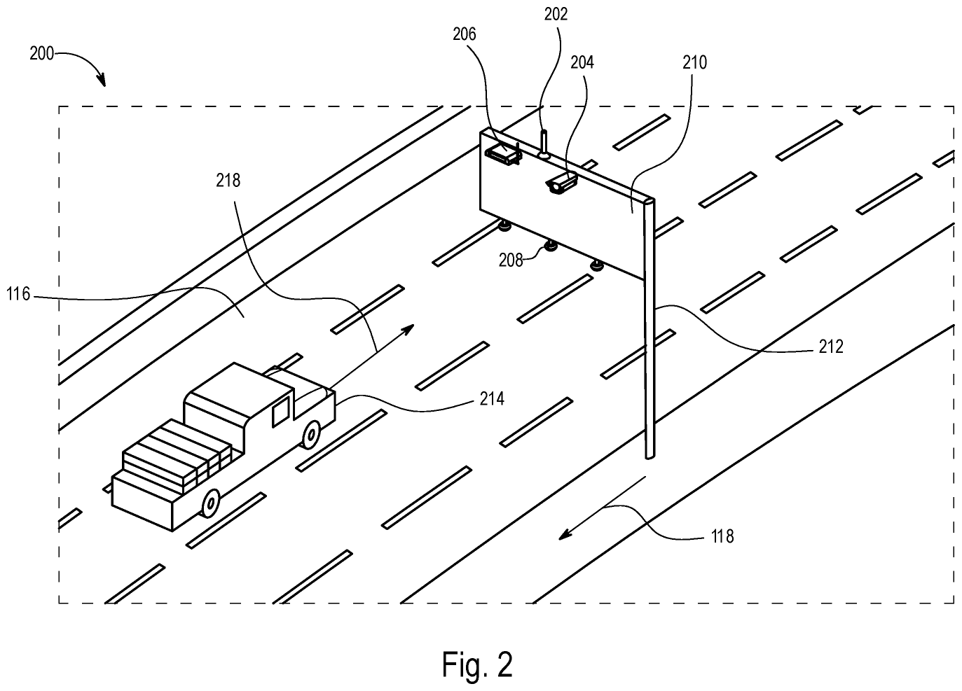

Referring to FIG. 2, FIG. 2 illustrates an example of the collision avoidance device 200, according to an embodiment of the present disclosure. The collision avoidance device 200 can detect a vehicle that is driving onto the highway in the wrong direction. In response to detecting the vehicle that is driving in the wrong direction, the collision avoidance device 200 may warn other drivers about the vehicle driving toward them and suggest an alternative route.

In the embodiment shown in FIG. 2, the collision avoidance device 200 includes an antenna 202, a camera 204, a radar 206, a sensor 208, a digital sign board 210, and a mount 212. The collision avoidance device 200 is designed to detect a wrong-way driver 214 that drives against a correct direction of traffic 118. The antenna 202 may be attached to the digital sign board 210 at various positions. The antenna 202 may transmit data via various protocols such as 3G, LTE, 5G, and wifi networks. The antenna 202 transmission may be received by authorities such as police, the general public, and other collision avoidance devices 200.

The camera 204 may be attached to the digital sign board 210 at various positions and angles. The camera 204 may detect a vehicle driving the wrong way on the highway 116. The camera 204 may use stereoscopic vision, night vision, or infrared vision. Images and video taken by the camera 204 may be processed by a machine learned algorithm that has been taught to recognize the position and angle of a vehicle. The machine learned algorithm may be taught such that it can recognize the make, model, and color of a vehicle based on an image or video of the vehicle. Once a vehicle is identified by a camera 204 image, the collision avoidance device 200 can produce a description of the vehicle and send the information to the antenna 106.

The radar 206, like the camera 204, may be used to detect a vehicle driving the wrong way on a highway 116. The radar 206 may detect the distance and speed of the vehicle. In various embodiments, the radar 206 may be located underneath or on top of the digital sign board 210 or attached to the mount 212. The radar 206 may use various radar technologies such as pulse radar, continuous radar, moving target indication radar, frequency modulated continuous wave radar, passive radar, Fm-cw radar, or doppler radar.

The digital sign board 210 may be attached to a mount 212. The back of the digital sign board 210 is shown in FIG. 2. The camera 204 and the radar 206 may be attached behind the digital sign board 210. The back of the digital sign board 210 may hold the camera 204 and the radar 206 to enable the camera 204 and the radar 206 to detect a vehicle driving in the wrong direction. In various embodiments, the digital sign board 210 may have a display screen to warn the wrong-way driver. The digital sign board 210 screen may comprise various display technologies such as liquid crystal display (LCD), organic light emitting diode (OLED), light emitting diode (LED), plasma, or quantum dot display (QLED).

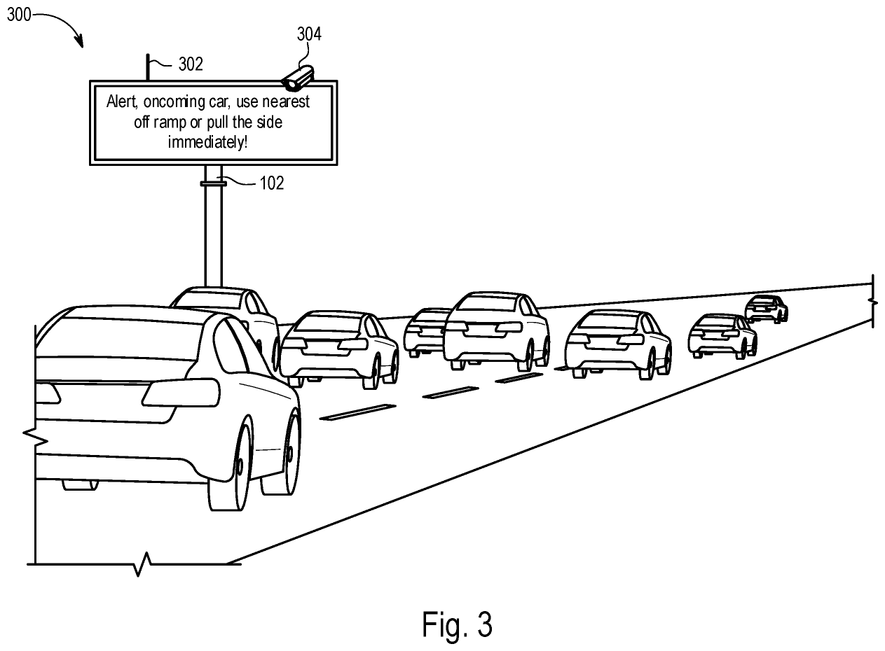

Referring to FIG. 3, FIG. 3 illustrates an example of the collision avoidance device 300, according to an embodiment of the present disclosure. The collision avoidance device 300 includes a digital sign board 302 that displays a digital message 304. The digital sign board 302 is a digital sign with an LCD screen that can produce written messages to the general public. The digital sign board 302 is elevated and extends over the highway. The digital messages 304 produced by the digital sign board 302 may be emergency warnings to the right-way driver regarding the wrong-way driver 214.

The collision avoidance device 300 may warn the general public about a vehicle driving the wrong way by displaying the digital messages 304 on the digital sign board 302. Drivers in the general public may be able to read the digital messages 304 in time to avoid an approaching wrong-way driver 214.

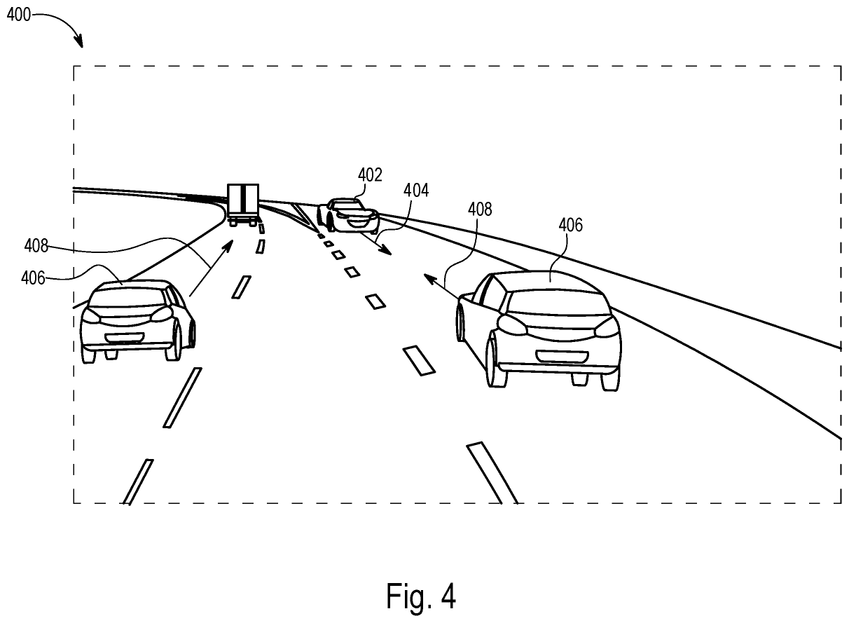

Referring to FIG. 4, FIG. 4 is an illustration 400 of a vehicle driving the wrong way on a road. The collision avoidance system may give vehicles on a highway a warning to take evasive action to avoid the wrong-way driver. The illustration 400 shows a wrong-way driver 402, the wrong direction 404, a right-way driver 406 and a right direction 408.

As shown in FIG. 4, a wrong-way driver 402 drove in the wrong direction 404 onto the highway 116 using the off ramp. The wrong-way driver 402 is approaching the right-way driver 406 who is driving in the right direction 408. As shown in the illustration, the right-way drivers 406 have a short distance with which to respond to the wrong-way driver 402. A warning may be received from the collision avoidance system, which could significantly aid the right-way drivers 406 in an action to avoid the wrong-way driver.

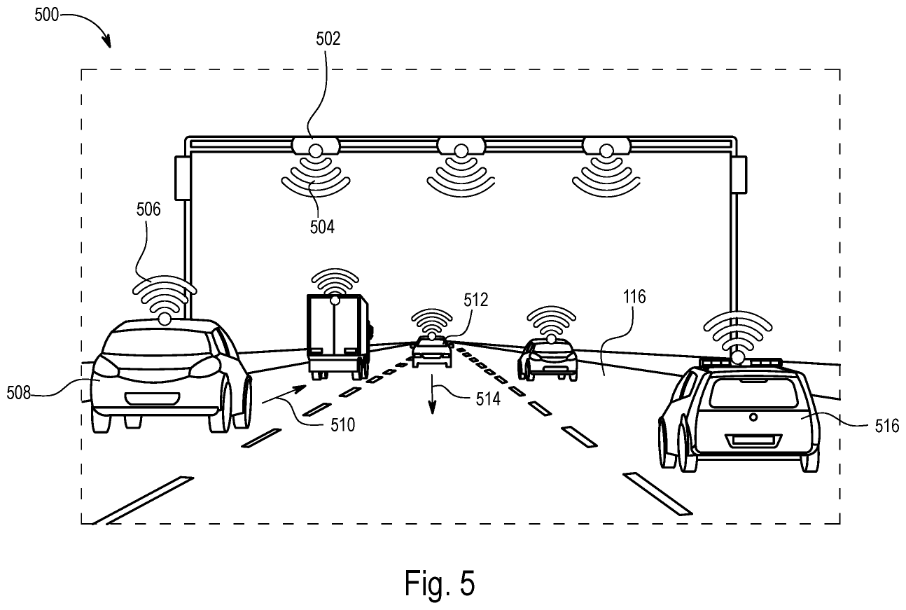

Referring to FIG. 5, FIG. 5 illustrates an example of a collision avoidance system 500, according to an embodiment of the present disclosure. The collision avoidance system 500 may include a mount with sensors and an antenna 502. As shown in FIG. 5 a right-way vehicle 508 travels in a correct direction 510 and a wrong-way vehicle 512 travels in a wrong direction 514. A mount that straddles the road may hold sensors that are capable of detecting a vehicle that is driving in the wrong direction on the road. The mount may also hold an antenna 502 at various positions on the mount. The antenna 502 may transmit a message in response to the sensors detecting a vehicle driving in the wrong direction. The antenna 502 transmission may be received by authorities and the general public. In various embodiments, the antenna 502 may be shaped in a dish, flat, rectangular, square, or thinner shape.

The right-way vehicle 508 may receive the transmitted signal from the antenna 502. The received signal may be communicated through a display within the right-way vehicle 508. The received signal may also be communicated through an audio speaker in the right-way vehicle 508. The communication within the right-way vehicle 508 may instruct the right-way vehicle 508 to take evasive action. Additionally, the communication may display a rendering of the road with an indication of the lane within which the wrong-way vehicle is travelling.

In various embodiments, a driver of the wrong-way vehicle 512 may receive the transmitted signal from the antenna as a warning to turn around or pull over. A police car 516 may also receive the transmitted signal sent 504 from the antenna 502 and may be warned about the wrong-way vehicle 512 driving in the wrong direction 514.

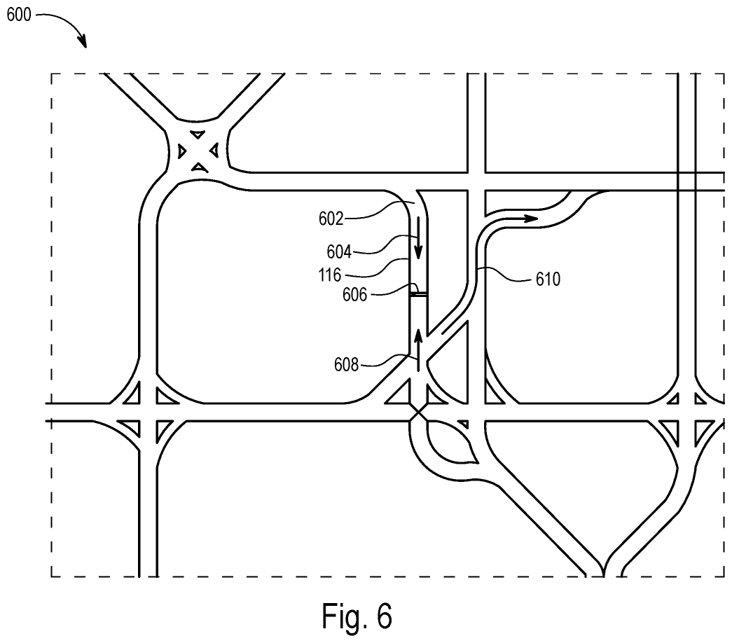

Referring to FIG. 6, FIG. 6 illustrates a diagram of the collision avoidance device 600 as it operates from an overhead view. The collision avoidance device 600 may detect a wrong-way vehicle 602 that is driving in a wrong direction. The collision avoidance device 600 may include a digital sign board 606. As shown in FIG. 6, the wrong-way vehicle 602 is driving in the wrong direction 604 on the highway 116 and is approaching the digital sign board 606.

The digital sign board 606 is located in the path of the wrong-way vehicle 602 and may detect the approaching wrong-way vehicle 602. In response to detecting the wrong-way vehicle 602, the digital sign board 606 may display a warning to the traffic traveling in the right direction 608. In one example of a warning, the digital sign board 606 may suggest to the traffic traveling in the right direction 608 an alternative route 610 in order to avoid the wrong-way vehicle 602.

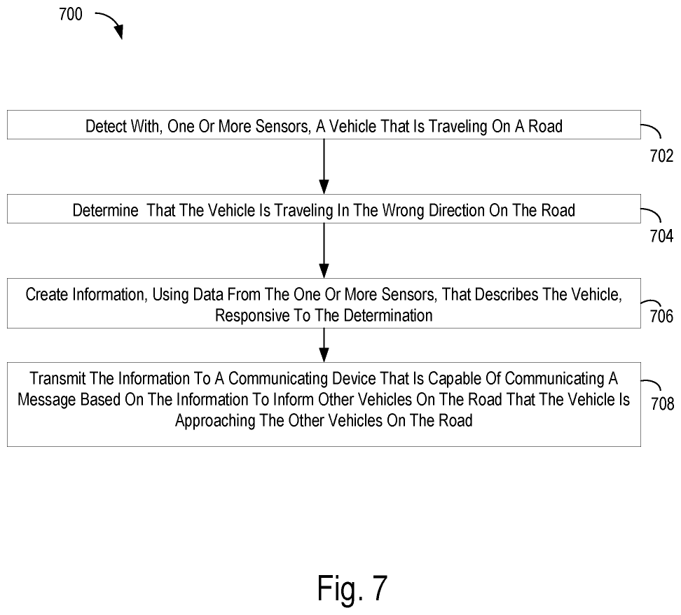

Referring to FIG. 7, FIG. 7 illustrates an example of a flow diagram 700 according to an embodiment of the present disclosure. Depending on the implementation, the flow diagram 700 may include additional, fewer, or alternative steps performed in various orders or in parallel. At step 702, the collision avoidance device may detect with, one or more sensors, a vehicle that is traveling on a road. In various embodiments, the one or more sensors may be a camera and radar. Data collected from the sensors may be transmitted to a controller, which perceives the vehicle and determines a position and velocity of the vehicle.

At step 704, the collision avoidance device may determine that the vehicle is traveling in the wrong direction on the road. Once the position and velocity of the vehicle are determined by the controller, the controller may determine that a vehicle is traveling in the wrong direction based on the velocity of the vehicle for a given position. The controller may trigger an alert for vehicles that are determined to be travelling in the wrong direction.

At step 706, the collision avoidance device may create information, using data from the one or more sensors, that describes the vehicle, responsive to the determination. The information may be limited to the determination that the vehicle is travelling in the wrong direction in a location. The information may include an image of the vehicle and a likely future position. The information may include evasive action that may be taken to avoid the vehicle.

At step 708, the collision avoidance device may transmit the information to a communicating device that is capable of communicating a message based on the information to inform other vehicles on the road that the vehicle is approaching the other vehicles on the road. The communicating device may be a digital sign board that displays a message to drivers on the road. The communicating device may be speakers on the side of the road. The communicating device may be a display inside another vehicle that is driving on the road.

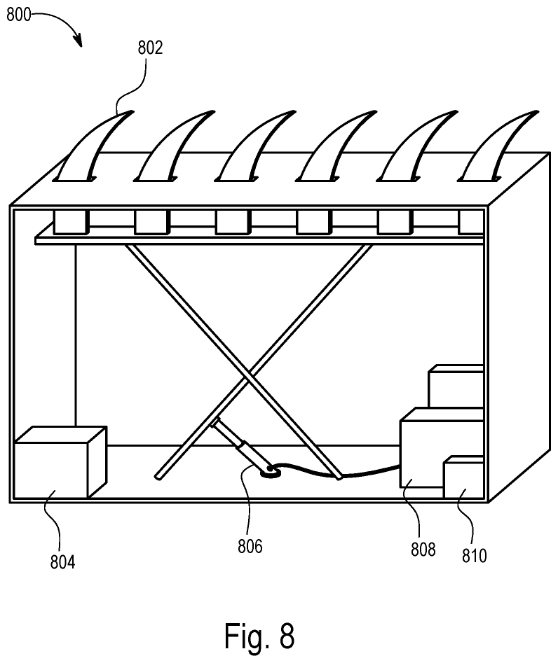

Referring to FIG. 8, FIG. 8 illustrates a diagram of the vehicle disabling component 800 for the collision avoidance device, according to an embodiment of the present disclosure. The vehicle disabling component 800 shown in FIG. 8 is a retractable spike strip that may slash the tires of the wrong-way vehicle. In various embodiments, the vehicle disabling component 800 may comprise an electric signal containing digital instructions that, when executed, cause the engine of the wrong-way vehicle to shut down.

The vehicle disabling component 800 may include retractable spikes 802, a communication component 804, a hydraulic lifting device 806, an electric motor 808, and an emergency vehicle pre-emption device 810. The retractable spikes 802 may be long, curved protruding objects out of the ground. The retractable spikes are on top of the hydraulic lifting device 806. In various embodiments, the retractable spikes may have increased curvature, longer, shorter, or made of steel, aluminum, brass, copper, stainless steel, wrought iron, iron, or titanium.

The vehicle disabling component 800 may be able to stop a vehicle entering an off ramp by slashing the vehicle's tires using the retractable spikes 802. The retractable spikes 802 are curved, protruding structures out of the ground. The retractable spikes 802 may be retracted by the hydraulic lifting device 806. The hydraulic lifting device 806 is powered by the electric motor 808. A signal may be transmitted to the communication component 804 to turn the electric motor on or off. The emergency vehicle pre-emption device 810 may receive a signal from an emergency vehicle and transmit the signal to the electric motor to turn it on or off.

The communication component 804 is attached to the electric motor 808. The communication component 804 may receive a signal in response to a determination by the collision avoidance device that there is a wrong-way vehicle approaching. The controller of the collision avoidance device may direct the antenna to transmit a signal to the vehicle disabling component 800, that is received by the communication component 804, that instructs the vehicle disabling component 800 to extend the retractable spikes 802 at the moment that the wrong-way vehicle is crossing the vehicle disabling component 800. The communication component 804 may transmit the signal to the electric motor 808 to turn it on or off.

The hydraulic lifting device 806 may be attached underneath the retractable spikes 802 and is powered by the electric motor 808. In various embodiments, the hydraulic lifting device 806 may be powered by an electric or gas motor. The electric motor 808 is beside the hydraulic lifting device 806 and powers the hydraulic lifting device 806. The electric motor 808 is connected to the communication component 804 above and beside the emergency vehicle pre-emption device 820. In various embodiments, the electric motor may be an AC asynchronous motor, AC synchronous motor, DC motor, or a combustion engine.

The emergency vehicle pre-emption device 810 is located besides the electric motor 808. The emergency vehicle pre-emption device 810 may detect an emergency vehicle and transmit a signal to the electric motor 808 to lower the retractable spikes 802 via the hydraulic lifting device 806. In various embodiments, the emergency vehicle pre-emption device 810 may use the global positioning system, localized radio signal, line-of-sight, or acoustic mechanisms to detect an emergency vehicle.

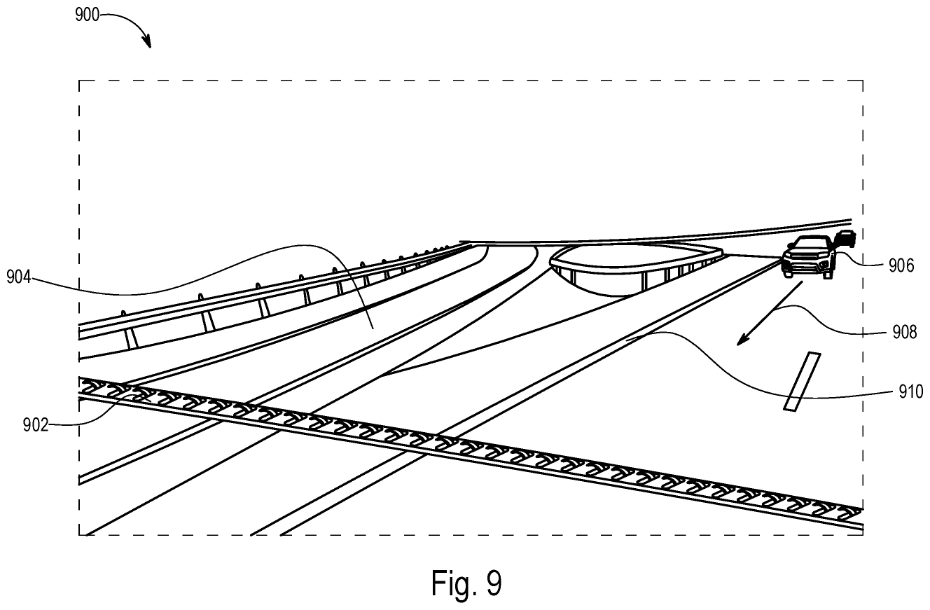

Referring to FIG. 9, FIG. 9 illustrates an example of the collision avoidance device 900 with a vehicle disabling component, according to an embodiment of the present disclosure. In the embodiment shown in FIG. 9, the collision avoidance device 900 includes a vehicle disabling component that may slash the tires of the oncoming vehicle.

The collision avoidance device 900 may include retractable spikes 902 positioned on an off ramp 904. As shown in FIG. 9, a right-way vehicle 906 drives in a right direction 908 on a street 910. The retractable spikes 902 are located across the off ramp 904. The retractable spikes 902 may be long, curved protruding objects out of the ground. The collision avoidance device 900 may extend the retractable spikes 902 when it determines that a vehicle is travelling in the wrong direction on the street 910. The retractable spikes 902 may prevent vehicles from driving onto the off ramp 904 by slashing the vehicle's tires with the retractable spikes 902.

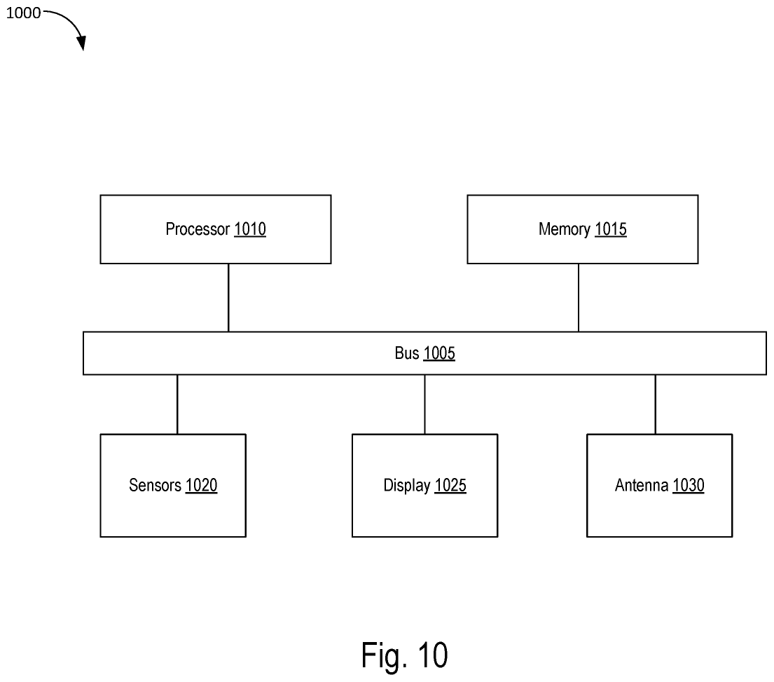

Referring to FIG. 10, FIG. 10 is a schematic of a computing system 1000 that may be used in the controller 178 of the collision avoidance device. The computing system 1000 may include a bus 1005, a processor 1010, memory 1015, sensors 1020, a display 1025, and an antenna 1030. The bus 1005 may connect the various components of the computing system 1000. The processor 1010 executes instructions that are transmitted to the processor 1010 through the memory 1015. Executed instructions are transmitted from the processor back to the memory 1015. The processor 1010 may comprise a central processing unit (“CPU”), a general-purpose graphic processing unit (“GPGPU”), a field programable gate array (“FPGA”), a complex programmable logic device (“CPLD”), or the like.

The memory 1015 stores data, transmits instructions to the processor 1010, and receives executed instructions from the processor 1010. The memory 1015 transmits instructions to the various components of the computing system 1000 including the sensors 1020, the display 1025, and the antenna 1030. The memory 1015 also receives data from the various components of the computing system 1000. Various types of memory 1015 include random access memory (“RAM”) and read only memory (“ROM”).

Data from the sensors 1020 may be transmitted to the memory 1015 and processor 1010 to determine if the data indicates that a vehicle is travelling in the wrong direction on a road. In response to the determination of the vehicle travelling in the wrong direction, the processor 1010 and memory 1015 may instruct the display 1025 to show an alert. The antenna 1030 may also be instructed to transmit the alert.

The disclosed subject matter may be practiced in many variations of the embodiments described herein. It is intended that the scope of this disclosure include all the variations of the many embodiments. Features and aspects of the disclosed subject matter should not be construed as being restricted by the terminology used herein. Instead, the scope of this disclosure should be construed in accordance with the appended claims.

1. A method to prevent highway collisions, the method comprising:
detecting, a vehicle, with one or more sensors, that is traveling on a road;
determining that the vehicle is traveling in a wrong direction on the road;
creating information, using data from the one or more sensors, that describes the vehicle, responsive to the determination; and
transmitting the information to a communicating device that is capable of communicating a message based on the information to inform other vehicles on the road that the vehicle is approaching the other vehicles on the road.

2. The method of claim 1, wherein the communicating device is a signboard with a display.

3. The method of claim 1, wherein the one or more sensors comprise at least one of a camera or a radar.

4. The method of claim 1, wherein the information comprises a speed of the vehicle, a lane in which the vehicle is driving, and a distance to the vehicle.

5. The method of claim 1, wherein determining that the vehicle is traveling in the wrong direction on the road comprises determining that the vehicle is facing the wrong direction based on an image of the vehicle that is taken by the one or more sensors.

6. The method of claim 1, further comprising activating a vehicle disabling device that is configured to stop the vehicle.

7. The method of claim 1, wherein the communicating device comprises a display in one of the other vehicles.

8. A collision avoidance system, comprising:
one or more sensors that can detect a vehicle that is travelling on a road and create data based on the vehicle;
a computer that is configured to determine that the vehicle is traveling in a wrong direction on the road based on the data; and
the computer further configured to create information that describes the vehicle based on the data and transmit the information to a communicating device that is capable of communicating a message based on the information to inform other vehicles on the road that the vehicle is approaching the other vehicles on the road.

9. The collision avoidance system of claim 8 wherein the one or more sensors comprise at least one of a camera or a radar.

10. The collision avoidance system of claim 8, wherein the information comprises a speed of the vehicle, a lane in which the vehicle is driving, and a distance to the vehicle.

11. The collision avoidance system of claim 8, wherein the computer is configured to determine that the vehicle is traveling in the wrong direction on the road by determining that the vehicle is facing the wrong direction based on an image of the vehicle that is taken by the one or more sensors.

12. The collision avoidance system of claim 8, further comprising a vehicle disabling device that is configured to stop the vehicle.

13. The collision avoidance system of claim 8, wherein the communicating device comprises a display in one of the other vehicles.

14. A computer readable storage medium in a collision avoidance apparatus having data stored therein representing a software executable by a computer, the software comprising instructions that, when executed, cause the collision avoidance apparatus to perform:
detecting, a vehicle, with one or more sensors, that is traveling on a road;
determining that the vehicle is traveling in a wrong direction on the road;
creating information, using data from the one or more sensors, that describes the vehicle, responsive to the determination; and
transmitting the information to a communicating device that is capable of communicating a message based on the information to inform other vehicles on the road that the vehicle is approaching the other vehicles on the road.

15. The computer readable storage medium in a collision avoidance apparatus of claim 14, wherein the communicating device is a signboard with a display.

16. The computer readable storage medium in a collision avoidance apparatus of claim 14, wherein the one or more sensors comprise at least one of a camera or a radar.

17. The computer readable storage medium in a collision avoidance apparatus of claim 14, wherein the information comprises a speed of the vehicle, a lane in which the vehicle is driving, and a distance to the vehicle.

18. The computer readable storage medium in a collision avoidance apparatus of claim 14, wherein determining that the vehicle is traveling in the wrong direction on the road comprises determining that the vehicle is facing the wrong direction based on an image of the vehicle that is taken by the one or more sensors.

19. The computer readable storage medium in a collision avoidance apparatus of claim 14, further comprising activating a vehicle disabling device that is configured to stop the vehicle.

20. The computer readable storage medium in a collision avoidance apparatus of claim 14, wherein the communicating device comprises a display in one of the other vehicles.
